(19) United States
(12) Patent Application Publication
(10) Pub. No.: US 2025/0244586 A1
(43) Pub. Date: Jul. 31, 2025

(54) PROJECTION OPTICAL SYSTEM AND GLASSES-TYPE TERMINAL

(71) Applicant: Cellid, Inc., Tokyo (JP)

(72) Inventors: Toshiaki SHOZU, Tokyo (JP); Susumu TATEOKA, Tokyo (JP); Tatsuo INABATA, Tokyo (JP); Satoshi SHIRAGA, Tokyo (JP); Shotaro OGURA, Tokyo (JP); Masashi MITSUI, Tokyo (JP)

(73) Assignee: Cellid, Inc., Tokyo (JP)

(21) Appl. No.: 19/046,537

(22) Filed: Feb. 6, 2025

Related U.S. Application Data
(63) Continuation of application No. PCT/JP2022/040182, filed on Oct. 27, 2022.

(30) Foreign Application Priority Data
Aug. 8, 2022 (WO) PCT/JP2022/030271

(51) Int. Cl. G02B 27/01; G02B 27/28

(52) U.S. Cl. CPC G02B 27/0172; G02B 27/286; G02B 27/288; G02B 2027/0112; G02B 2027/0178

(57) ABSTRACT

A projection optical system includes: a projection substrate for projecting an image light onto a second surface while transmitting at least a part of light incident from a first surface to the second surface opposite to the first surface, the projection substrate having an optical waveguide; and a diffracted light reduction plate that is provided on the first surface side of the projection substrate with an air layer between itself and the optical waveguide, covers at least a part of the optical waveguide, which diffracts an input light incident from the first surface of the projection substrate at a predetermined incident angle, and reduces diffracted light that travels in an emission direction of the image light, wherein the optical waveguide guides at least a part of projection light for projecting the image light, and emits that part of the projection light as the image light from the second surface.

### CROSS-REFERENCE TO RELATED APPLICATIONS

The present application is a continuation application of International Application number PCT/JP2022/040182, filed on Oct. 27, 2022, which claims priority under 35 U.S.C § 119(a) to International Application number PCT/JP2022/030271, filed on Aug. 8, 2022, contents of which are incorporated herein by reference in their entirety.

The present invention relates to a projection optical system and a glasses-type terminal.

### BACKGROUND OF THE INVENTION

Conventionally, an eyeglass-type device, a head mounted display, and the like have been known for displaying two-dimensional images to be observed by a user, utilizing an optical system including a waveguide and the like (for example, refer to Japanese Unexamined Patent Publication No. 2017-207686 and WO2015/111523.).

Since such devices incorporate the optical system into limited space, the optical system may become complex. In addition, when the optical system includes a diffraction grating or the like, light incident at a predetermined angle may be diffracted and enter the user's eyes.

### BRIEF SUMMARY OF THE INVENTION

In view of these issues, the present invention aims to reduce diffracted light traveling in the direction of the user's eyes, with a simple configuration in a device that displays two-dimensional images for observation by the user.

A first aspect of the present invention provides a projection optical system including: a projection substrate for projecting an image light onto a second surface while transmitting at least a part of light, that is incident from a first surface, to the second surface opposite to the first surface, the projection substrate having an optical waveguide; and a diffracted light reduction plate that (i) is provided on the first surface side or the second surface side of the projection substrate, with an air layer between itself and the optical waveguide, (ii) covers at least a part of the optical waveguide, which diffracts an input light incident from the first surface of the projection substrate at a predetermined incident angle, and (iii) reduces diffracted light that travels in an emission direction of the image light, wherein the optical waveguide guides at least a part of projection light for projecting the image light, and emits the at least part of the projection light as the image light from the second surface.

A second aspect of the present invention provides a glasses-type terminal worn by a user, including: the projection optical system according to the first aspect, which is provided as at least one of a lens for the right eye and a lens for the left eye of the user, and projects the image light onto the second surface while transmitting at least a part of light incident from the first surface to the eye of the user; a frame that fixes the projection optical system; and a projection unit that is provided in the frame and radiates the projection light, for causing the image light to be projected onto an emission region of the optical waveguide, onto an incident region of the optical waveguide of the projection substrate.

### BRIEF DESCRIPTION OF THE DRAWINGS

FIG. 1 shows a first configuration example of a glasses-type terminal 10 according to the present embodiment.

FIG. 2 shows an outline of an optical path of a projection light in the glasses-type terminal 10 according to the present embodiment.

FIG. 3 shows an outline of the optical path of the projection light in a projection substrate 100 according to the present embodiment.

FIG. 4 shows an example of a projection light which is radiated from a projection unit 120 according to the present embodiment to the projection substrate 100, and an image light emitted from the projection substrate 100.

FIG. 5 shows a configuration example of the projection substrate 100 according to the present embodiment.

FIG. 6 shows a second configuration example of the glasses-type terminal 10 according to the present embodiment.

FIG. 7 shows a third configuration example of the glasses-type terminal 10 according to the present embodiment.

FIG. 8 shows a fourth configuration example of the glasses-type terminal 10 according to the present embodiment.

FIG. 9 shows a fifth configuration example of the glasses-type terminal 10 according to the present embodiment.

FIG. 10 shows a sixth configuration example of the glasses-type terminal 10 according to the present embodiment.

FIG. 11 shows a seventh configuration example of the glasses-type terminal 10 according to the present embodiment.

FIG. 12 shows an example of transmittance characteristics of a light control filter 410 according to the present embodiment.

### DETAILED DESCRIPTION OF THE INVENTION

Hereinafter, the present invention will be described through exemplary embodiments, but the following exemplary embodiments do not limit the invention according to the claims, and not all of the combinations of features described in the exemplary embodiments are necessarily essential to the solution means of the invention.

### First Configuration Example of Glasses-Type Terminal 10

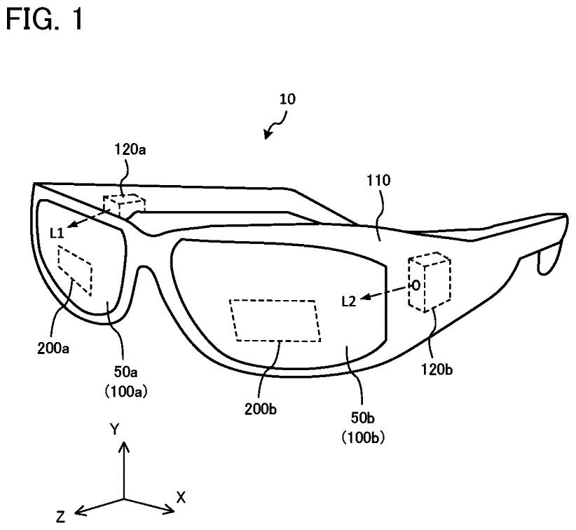

FIG. 1 shows a first configuration example of a glasses-type terminal 10 according to the present embodiment. In this embodiment, three mutually orthogonal axes are designated as the X-axis, Y-axis, and Z-axis. The glasses-type terminal 10 is a wearable device worn by a user, for example. The glasses-type terminal 10 projects an image light onto a display region provided on a projection substrate 100 while having a user observe a view through glasses. The glasses-type terminal 10 includes a projection optical system 50, a frame 110, and a projection unit 120.

The projection optical system 50 includes the projection substrate 100 and a diffracted light reduction plate 310. In FIG. 1, the projection substrate 100 of the projection optical system 50 is shown, and the diffracted light reduction plate 310 is omitted. The diffracted light reduction plate 310 will be described later.

The projection substrate 100 includes an optical waveguide 200, and projects the image light onto a second surface while transmitting at least a part of the light entering from a first surface to the eyes of the user. Here, the first surface of the projection substrate 100 is a surface facing the side opposite to the user when the user is wearing the glasses-type terminal 10. The second surface of the projection substrate 100 is a surface facing the user when the user is wearing the glasses-type terminal 10. FIG. 1 shows an example in which the first surface and the second surface of the projection substrate 100 are disposed approximately parallel to an XY plane.

The projection substrate 100 is, for example, a glass substrate on which the optical waveguide 200 is formed. The optical waveguide 200 guides at least a part of projection light for projecting the image light incident from the second surface of the projection substrate 100, and emits that part of the projection light as the image light from the second surface. The projection substrate 100 will be described later.

The frame 110 fixes the projection optical system 50. The frame 110 is provided with the projection optical system 50 as at least one of a lens for the right eye or a lens for the left eye of the user. FIG. 1 shows an example in which a projection optical system 50a is provided as the lens for the right eye of the user on the frame 110, and a projection optical system 50b is provided as the lens for the left eye.

Alternatively, the frame 110 may be provided with one projection optical system 50 as the lens for the right eye or the lens for the left eye of the user. Further, the frame 110 may be provided with one projection optical system 50 as a lens for both eyes of the user. In this case, the frame 110 may have a goggle shape. The frame 110 has parts such as a temple, a strap, and the like so that the user can wear the glasses-type terminal 10.

The projection unit 120 is provided in the frame 110 and radiates the projection light, for causing the image light to be projected onto the projection substrate 100, toward the projection optical system 50. The frame 110 is provided with one or a plurality of such projection units 120. FIG. 1 shows an example in which (i) a projection unit 120a for irradiating the projection optical system 50a (projection substrate 100a) with a projection light L1 and (ii) a projection unit 120b for irradiating the projection optical system 50b (projection substrate 100b) with a projection light L2 are provided in the frame 110.

The projection unit 120 may be provided at a portion of the frame 110 to which the projection optical system 50 is fixed, or may be provided in the temple or the like of the frame 110. The projection unit 120 is preferably provided integrally with the frame 110. For example, the projection unit 120 radiates a projection light including one wavelength onto the projection optical system 50, allowing the user to observe a monochrome image. Further, the projection unit 120 may radiate the projection optical system 50 with a projection light including a plurality of wavelengths, allowing the user to observe an image including multiple colors.

Next, the projection optical system 50 will be described. First, the operation of the projection substrate 100 within the projection optical system 50 will be described, followed by a description of a diffracted light reduction plate 310.

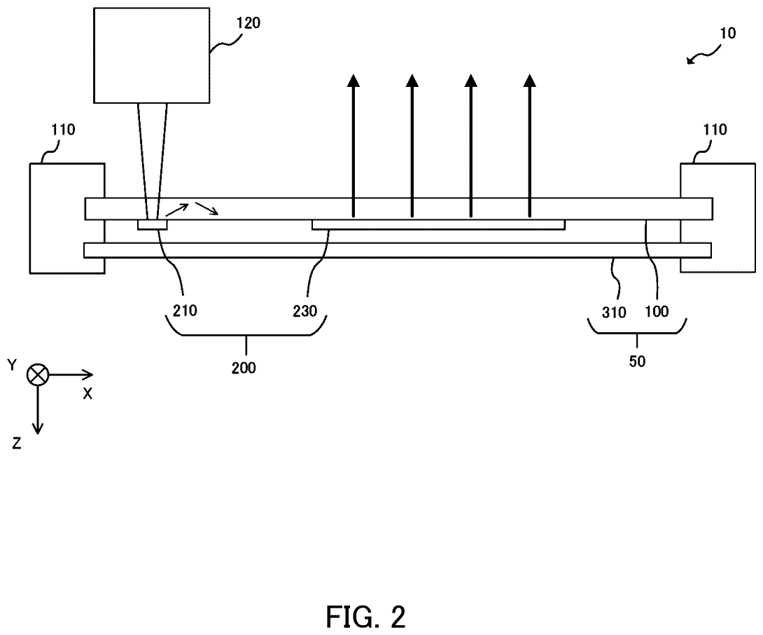

FIG. 2 shows an outline of an optical path of a projection light in the glasses-type terminal 10 according to the present embodiment. The projection unit 120 radiates the projection light onto an incident region 210 of the optical waveguide 200 of the projection substrate 100. The incident region 210 guides the projection light into a substrate of the projection substrate 100. Then, at least a part of the projection light guided in the substrate is emitted as an image light from the emission region 230 of the optical waveguide 200. The incident region 210 and the emission region 230 will be described later.

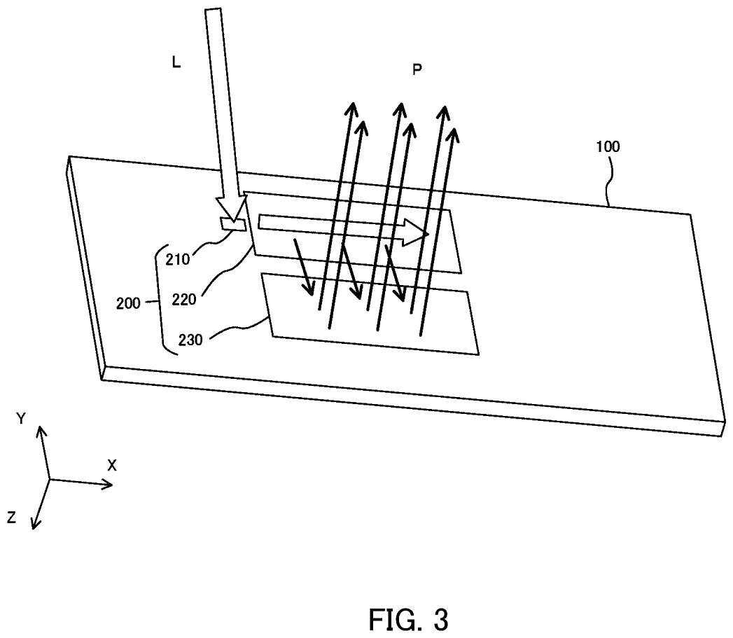

FIG. 3 shows an outline of an optical path of a projection light in the projection substrate 100 according to the present embodiment. As will be described later, the optical waveguide 200 includes the incident region 210, an intermediate region 220, and the emission region 230. A projection light L enters the incident region 210 and is emitted from the emission region 230 through the intermediate region 220 as an image light P. The intermediate region 220 guides the projection light L to the emission region 230, part by part, as the projection light L travels away from the incident region 210.

Similarly, as the projection light L travels away from the intermediate region 220, the emission region 230 also emits portions of the projection light L as part of the image light P. By doing this, the projection substrate 100 emits, as the image light P, the projection light L incident on the incident region 210 from the emission region 230.

Here, an example is conceived of in which the intermediate region 220 guides the projection light L to the emission region 230 at a constant rate throughout the entire region of the intermediate region 220. In this case, since the quantity of the projection light L decreases as the projection light L travels away from the incident region 210, the intensity of the projection light L entering the emission region 230 from the intermediate region 220 may differ depending on a distance from the incident region 210.

Similarly, an example is conceived of in which the emission region 230 emits, as the image light P, the projection light L at a constant rate throughout the entire region of the emission region 230. In this case, since the quantity of the projection light L decreases as the projection light L travels away from the intermediate region 220, the intensity of the image light P emitted from the emission region 230 may differ depending on a distance from the incident region 210 and a distance from the emission region 230. For example, luminance may gradually decrease from the upper left pixels to the lower right pixels of an image projected by the emission region 230. The projection substrate 100 according to the present embodiment reduces such variations in the luminance.

### Example of the Projection Light and Image Light

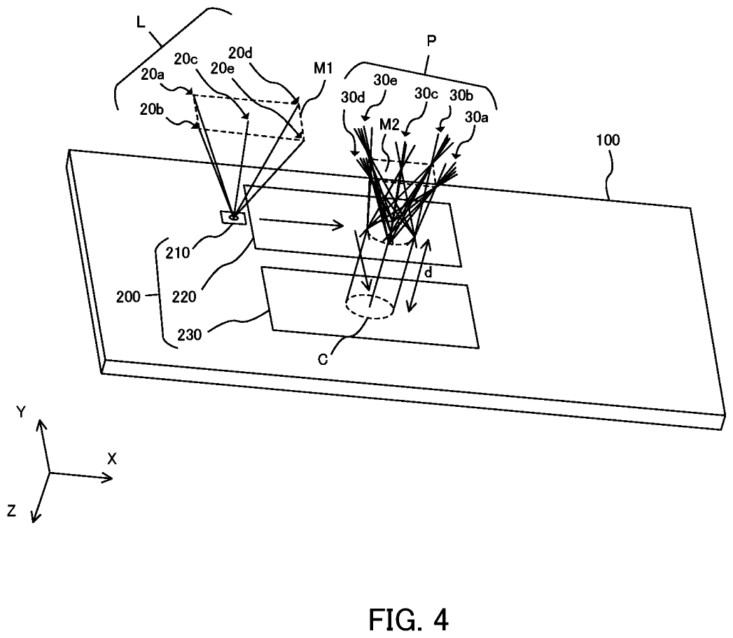

FIG. 4 shows an example of the projection light L radiated from the projection unit 120 to the projection substrate 100 and the image light P emitted from the projection substrate 100 according to the present embodiment. For example, the projection unit 120 radiates the projection light L toward the second surface of the projection substrate 100 positioned in the Z direction. The projection light L corresponds to an image to be shown to the user, and for example, when a screen or the like is installed on a plane approximately parallel to the XY plane and the projection light L is projected thereon, an image M1 to be observed by the user is displayed on that screen. The image to be shown to the user is an AR (Augmented Reality) image or a VR (Virtual Reality) image generated by a processor included in the projection unit 120, for example. In this way, the projection unit 120 radiates, as the projection light L, a plurality of light rays forming the image M1 on the plane approximately parallel to the XY plane.

In this embodiment, an example in which the projection unit 120 projects an approximately rectangular image M1, whose longitudinal direction is the X-axis direction on the plane, approximately parallel to the XY plane will be described. In FIG. 4, five light rays, from among the plurality of light rays radiated by the projection unit 120, are shown as input light rays 20. For example, a light ray corresponding to the upper left pixels of the image is a first input light ray 20a, a light ray corresponding to the lower left pixels of the image is a second input light ray 20b, a light ray corresponding to the center pixels of the image is a third input light ray 20c, a light ray corresponding to the upper right pixels of the image is a fourth input light ray 20d, and a light ray corresponding to the lower right pixels of the image is a fifth input light ray 20e.

For example, the projection unit 120 irradiates the incident region 210 of the projection substrate 100 with such projection light L so as to form an upright virtual image at infinity or at a predetermined position. The projection light incident on the incident region 210 passes through the intermediate region 220 and is emitted from the emission region 230 as the image light P. The image light P is emitted from the emission region 230 and enters the user's eyes, which are at a distance d from the projection substrate 100. The image light P forms an image M2 on the retina of the user's eyes. In this way, the image light P includes a plurality of light fluxes that form the image M2.

In FIG. 4, five light fluxes, from among a plurality of light fluxes which are radiated from a circular region C of the emission region 230 of the projection substrate 100 and formed into an image at a predetermined position, are shown as output light fluxes 30. For example, a light flux formed into an image as the lower right pixels of the image M2 is designated as a first output light flux 30a, a light flux formed into an image as the upper right pixels of the image M2 is designated as a second output light flux 30b, a light flux formed into an image as the center pixels of the image M2 is designated as a third output light flux 30c, a light flux formed into an image as the lower left pixels of the image M2 is designated as a fourth output light flux 30d, and a light flux formed into an image as the upper left pixels of the image M2 is designated as a fifth output light flux 30e.

Each light flux corresponds to one of the plurality of input light rays 20 entering from the projection unit 120. For example, the first output light flux 30a corresponds to the first input light ray 20a, and the first output light flux 30a includes a plurality of light rays generated by a plurality of splittings, diffractions, and the like of the first input light ray 20a that take place from the incident region 210 to the emission region 230 of the projection substrate 100. Similarly, the second output light flux 30b corresponds to the second input light ray 20b, the third output light flux 30c corresponds to the third input light ray 20c, the fourth output light flux 30d corresponds to the fourth input light ray 20d, and the fifth output light flux 30e corresponds to the fifth input light ray 20e.

In other words, the image M2, which is the image light P emitted from the emission region 230 and formed on the retina of the user's eyes, corresponds to the image M1 projected with the projection light L radiated by the projection unit 120. In this way, the user wearing the glasses-type terminal 10 can perceive the image M2 as if it were projected onto the second surface of the projection substrate 100, superimposed on a view seen through the projection substrate 100. In other words, the emission region 230 functions as the display region for displaying the image M2 corresponding to the image M1 projected with the projection light L.

In FIG. 4, the image M2 observed by the user is an image obtained by inverting the image M1 projected with the projection light L vertically and horizontally. The image M1 projected with the projection light L may be a still image, or instead, may be a moving image. The projection substrate 100 that emits the image light P corresponding to the incident projection light L will now be described.

### Configuration Example of the Projection Substrate 100

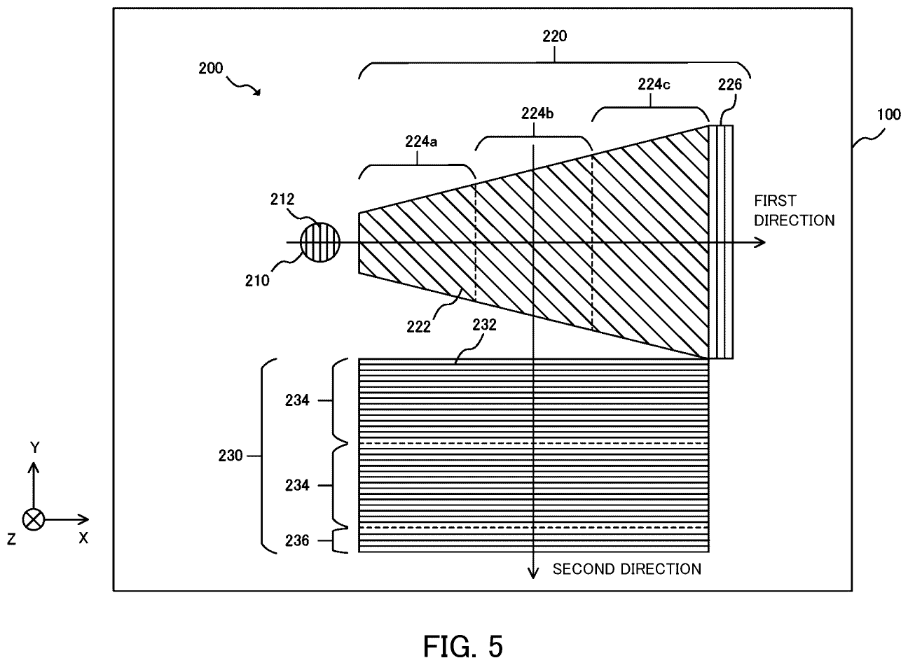

FIG. 5 shows a configuration example of the projection substrate 100 according to the present embodiment. FIG. 5 shows an example in which the first surface and the second surface of the projection substrate 100 are disposed approximately parallel to the XY plane. The projection substrate 100 is a substrate including the optical waveguide 200 for projecting the image light onto the second surface, which is the opposite side of the first surface, while transmitting at least a part of the light incident from the first surface to the second surface. The projection substrate 100 is a glass substrate, for example. The projection substrate 100 includes the optical waveguide 200 that includes the incident region 210, the intermediate region 220, and the emission region 230.

### Example of the Incident Region 210

A projection light for projecting an image light enters the incident region 210, and the incident region 210 guides the incident projection light toward the intermediate region 220. FIG. 5 shows an example in which the incident region 210 has a circular shape in a plane approximately parallel to the XY plane, but the present invention is not limited thereto. The incident region 210 may have a shape such as an ellipse, a polygon, or a trapezoid, as long as it can guide the projection light to the intermediate region 220.

The incident region 210 includes an input diffraction grating in which a plurality of first grooves 212 are formed with a first period. In other words, the plurality of first grooves 212 are arranged on the upper surface of the projection substrate 100 in the same direction with a predetermined groove width and interval, thereby functioning as the diffraction grating. The incident region 210 has a reflective or transmissive input diffraction grating and guides the projection light in a direction of the intermediate region 220 through reflective or transmissive diffraction. The first period of the plurality of first grooves 212 is in a range of about 10 nm to about 10 μm, for example.

The plurality of first grooves 212 are arranged in a direction from the incident region 210 toward the intermediate region 220, for example. Here, the traveling direction of the projection light from the incident region 210 toward the intermediate region 220 is referred to as a first direction. FIG. 5 shows an example in which the first direction is a direction approximately parallel to the X-axis direction, and the first grooves 212 extending in a direction approximately parallel to the Y-axis direction are arranged in the first direction. Since the projection light converges as it enters the incident region 210, the incident region 210 guides the projection light to the intermediate region 220 such that the projection light spreads out at a divergence angle centered on the first direction within the plane of the projection substrate 100.

### Example of the Intermediate Region 220

The intermediate region 220 guides a part of the projection light incident from the incident region 210 toward the emission region 230. The intermediate region 220 is provided in a region through which the projection light passes, in the plane approximately parallel to the XY plane. The intermediate region 220 has a reflective intermediate diffraction grating, and guides the projection light toward the emission region 230 through the reflective diffraction. The intermediate region 220 has a rectangular shape whose longitudinal direction is the first direction, for example.

Since the projection light travels while spreading out around the first direction, it is preferable for the intermediate region 220 to have a shape that widens as the distance from the incident region 210 increases, diverging from the first direction, which is a traveling direction of the projection light passing through the incident region 210. The intermediate region 220 has a trapezoidal shape, a fan shape, or the like in the plane approximately parallel to the XY plane, for example. FIG. 5 shows an example in which the intermediate region 220 has the trapezoidal shape. An intermediate region 220 with such a shape can be formed to correspond to a region where the projection light spreads while travelling in the XY plane, and can efficiently guide the projection light.

The intermediate region 220 includes an intermediate diffraction grating in which a plurality of second grooves 222 are formed with a second period. In other words, the plurality of second grooves 222 are arranged on the upper surface of the projection substrate 100 in the same direction with a predetermined groove width and interval, thereby functioning as the diffraction grating. The intermediate region 220 functions as, for example, a reflective intermediate diffraction grating, and guides the projection light to the emission region 230.

The second period of the plurality of second grooves 222 is different from the first period of the plurality of first grooves 212. As the second period, it is desirable to select an appropriate period for guiding the projection light to the emission region 230. The second period is, for example, in a range of about 10 nm to about 10 μm.

The plurality of second grooves 222 are arranged in a predetermined direction, for example. For example, a direction from the intermediate region 220 toward the emission region 230 is defined as a second direction, and an angle formed between the first direction and the second direction is defined as a first angle. In this case, the plurality of second grooves 222 are formed in a direction inclined toward the second direction by an angle of ½ of the first angle with respect to the first direction. FIG. 5 shows an example in which the second direction is a direction approximately parallel to the Y-axis direction, the first angle is approximately 90 degrees, and the plurality of second grooves 222 are arranged in the direction inclined toward the second direction by approximately 45 degrees with respect to the first direction.

The intermediate region 220 includes a plurality of first divided regions 224 arranged in the traveling direction of the incident projection light. The second grooves 222 formed in the plurality of first divided regions 224 have different depths. In other words, in the intermediate region 220, the second grooves 222 are formed such that a ratio of light guided to the emission region 230 within the incident projection light varies for each of the first divided regions 224.

The intermediate region 220 preferably includes three or more first divided regions 224. In this way, the intermediate region 220 is divided into the plurality of first divided regions 224, thereby varying the quantity of projection light guided to the emission region 230 for each of the first divided regions 224. By doing this, the distribution of the quantity of light in a direction perpendicular to the traveling direction of the projection light is adjusted to be approximately constant, while guiding the projection light with different intensities, depending on the distance from the incident region 210, to the emission region 230.

For example, the second grooves 222 are formed in such a way that the depth of the second groove 222 provided in one of the first divided regions 224 is greater than the depth of the second groove 222 provided in the first divided region 224, which is closer to the incident region 210 than that particular divided region 224. In this case, the rate of change of depth of the second grooves 222 of two adjacent first divided regions 224 among the plurality of first divided regions 224 may increase as the distance from the incident region 210 increases.

As an example, an intermediate region 220 having three first divided regions 224, as shown in FIG. 5, is considered. Here, it is assumed that a second groove 222a is formed with a depth such that the second groove 222a guides light with approximately ¼ of the quantity of the projection light incident on a first divided region 224a to the emission region 230 in the first divided region 224a, which is closest to the incident region 210 among the three first divided regions 224. In this case, approximately ¾ of the remaining quantity of the projection light incident on the first divided region 224a, which is closest to the incident region 210, enters an adjacent first divided region 224b.

It is assumed that a second groove 222b is formed with a depth such that the second groove 222b guides light with approximately ⅓ of the quantity of the projection light incident on the first divided region 224b to the emission region 230 in the first divided region 224b, which is second closest to the first divided region 224. In other words, the depth of the second groove 222b of the first divided region 224b, which is second closest to the incident region 210, is greater than the depth of the second groove 222a, so as to guide light having 4/3 times the quantity of light compared to the first divided region 224a, which is closest to the incident region 210, to the emission region 230. The first divided region 224b guides light with approximately ¼ of the quantity of the projection light incident on the first divided region 224a, which is closest to the incident region 210, to the emission region 230.

Then, approximately ½ of the remaining quantity of the projection light incident on the first divided region 224a, which is closest to the incident region 210, enters an adjacent first divided region 224c. It is assumed that a second groove 222c is formed with a depth such that the second groove 222c guides light with approximately ½ of the quantity of the projection light incident on the first divided region 224c to the emission region 230 in the first divided region 224c, which is third closest to the incident region 210. In other words, the depth of the second groove 222c of the first divided region 224c, which is third closest to the incident region 210, is greater than the depth of the second groove 222b, so as to guide light having 3/2 times the quantity of light compared to the first divided region 224b, which is closest to the incident region 210, to the emission region 230.

In addition, the second grooves 222 of the two adjacent first divided regions 224 among the three first divided regions 224 are formed in such a way that the rate of change of depth of these second grooves 222 increases as the distance from the incident region 210 increases. Then, the first divided region 224c, which is third closest to the incident region 210, guides light with approximately ¼ of the quantity of the projection light incident on the first divided region 224a, which is closest to the incident region 210, to the emission region 230. As in the above example, it can be understood that by adjusting the quantity of the projection light to be guided to the corresponding emission region 230 for each of the first divided regions 224 to a predetermined value, the intermediate region 220 can guide the projection light to the emission region 230 while ensuring approximately constant distribution of the quantity of the projection light guided to the respective emission regions 230.

The intermediate region 220 may further include a first reflection region 226 at a position furthest from the incident region 210. FIG. 5 shows an example in which the intermediate region 220 includes three first divided regions 224 and the first reflection region 226. The first reflection region 226 reflects at least a part of the light that has passed through the plurality of first divided regions 224 to the plurality of first divided regions 224 again. The first reflection region 226 includes second grooves 222 of greater depth than the depth of the second grooves 222 of the adjacent first divided region 224.

Since the intermediate region 220 includes such a first reflection region 226, the plurality of first divided regions 224 guide at least a part of the light reflected by the first reflection region 226 to the emission region 230. In this way, the intermediate region 220 can guide more projection light to the emission region 230. The depth of the second grooves 222 of the plurality of first divided regions 224 may be determined such that the quantity of projection light guided to the emission region 230 from each of the first divided regions 224, incorporating the reflected light from the first reflection region 226, is approximately constant.

### Example of the Emission Region 230

The emission region 230 guides at least a part of the projection light incident from the intermediate region 220 and emits that part of the projection light as an image light from the second surface of the projection substrate 100. FIG. 5 shows an example in which the emission region 230 has a rectangular shape whose longitudinal direction is the X-axis direction in a plane approximately parallel to the XY plane, but the present invention is not limited thereto. The emission region 230 may have a rectangular shape, a square shape, a trapezoid shape, or the like whose longitudinal direction is the Y-axis direction, as long as the emission region 240 can guide the projection light and emit it as the image light.

The emission region 230 has an output diffraction grating in which a plurality of third grooves 232 are formed with a third period. In other words, the plurality of third grooves 232 are arranged on the upper surface of the projection substrate 100 in the same direction with a predetermined groove width and interval, thereby functioning as the diffraction grating. The emission region 230 has a reflective or transmissive output diffraction grating and guides the image light toward the user's eye through reflective or transmissive diffraction.

The third period of the plurality of third grooves 232 provided in the emission region 230 is different from the second period of the plurality of second grooves 222 in the intermediate region 220. The third period of the plurality of third grooves 232 in the emission region 230 may be the same as the first period of the plurality of first grooves 212 in the incident region 210. By making the period of the diffraction grating provided in the region into which the projection light enters approximately coincide with the period of the diffraction grating provided in the region where the image light is emitted in this manner, it is possible to reduce distortion or similar effects in an image observed by the user. The third period is in a range of about 10 nm to about 10 μm, for example.

The plurality of third grooves 232 are arranged in the second direction, which is the direction from the intermediate region 220 toward the emission region 230, for example. FIG. 5 shows an example in which the third grooves 232 extending in the first direction are arranged in the second direction.

Similarly to the intermediate region 220, the emission region 230 includes a plurality of second divided regions 234 arranged in the traveling direction of the projection light incident from the intermediate region 220. The third grooves 232 formed in the plurality of second divided regions 234 have different depths. In other words, in the emission region 230, the third grooves 232 are formed such that a ratio of light which will be emitted as the image light within the incident projection light varies for each of the second divided regions 234.

The emission region 230 preferably includes two or more second divided regions 234. For example, the third groove 232 provided in one of the second divided regions 234 is assumed to have a depth greater than the depth of the third groove 232 provided in the second divided region 234, which is closer to the intermediate region 220 than that particular second divided region 234. Further, when the emission region 230 includes three or more second divided regions 234, the rate of change of depth of the third grooves 232 of two adjacent second divided regions 234 may increase as the distance from the intermediate region 220 increases.

As described above, the emission region 230 is divided into the plurality of second divided regions 234, resulting in variations in the quantity of light emitted as image light for each of the second divided regions 234. In this way, similarly to the plurality of first divided regions 224 of the intermediate region 220, by guiding the projection light as the image light, the emission region 230 can adjust the distribution of the quantity of light across the entire image to be approximately constant when observed by an observer as an image.

The emission region 230 may further include a second reflection region 236 at a position furthest from the intermediate region 220. FIG. 5 shows an example in which the emission region 230 includes two second divided regions 234 and the second reflection region 236. The second reflection region 236 reflects at least a part of the light that has passed through the plurality of second divided regions 234, to the plurality of second divided regions 234 again. The second reflection region 236 includes third grooves 232 of greater depth than the third grooves 232 of the adjacent second divided region 234.

Since the emission region 230 includes such a second reflection region 236, the plurality of second divided regions 234 emit, as the image light, at least a part of the light reflected by the second reflection region 236 from the second surface of the projection substrate 100. In this way, the emission region 230 can emit more projection light as the image light, similarly to the intermediate region 220. The depth of the third grooves 232 of the plurality of second divided regions 234 may be determined such that the quantity of light emitted as the image light from each of the second divided regions 234, incorporating the reflected light from the second reflection region 236, is approximately constant.

As described above, the projection substrate 100 according to the present embodiment splits the projection light entering the incident region 210 at different ratios for each of the plurality of first divided regions 224 of the intermediate region 220, and emits them as image lights from the emission region 230. By doing this, the projection substrate 100 can reduce variation in the luminance of the projection image to be observed by the user. In addition, the projection substrate 100 can further reduce variation in the luminance of the image by emitting the image light at different ratios for each of the plurality of second divided regions 234 in the emitting region 230.

Such a projection substrate 100 can be realized by forming the diffraction grating corresponding to the incident region 210, the diffraction grating corresponding the intermediate region 220, and the diffraction grating corresponding the emission region 230 on the front or rear surface of the glass substrate or the like. The grooves forming the diffraction grating are made of resist, resin, or the like, for example. Therefore, the projection substrate 100 according to the present embodiment is a substrate that can be easily produced by forming grooves with predetermined intervals and depths for each region, without incorporating complicated optical systems.

### Second Configuration Example of the Glasses-Type Terminal 10

Although an example of the glasses-type terminal 10 has been described above, in which one projection substrate 100 is provided on the frame 110 for each of the projection optical systems 50 for the right eye and the left eye, and the corresponding projection unit 120 irradiates the incident region 210 of each projection substrate 100 with the projection light, the present invention is not limited to this configuration. For example, one projection optical system 50 may include a plurality of projection substrates 100. Next, the glasses-type terminal 10 configured in this manner will be described.

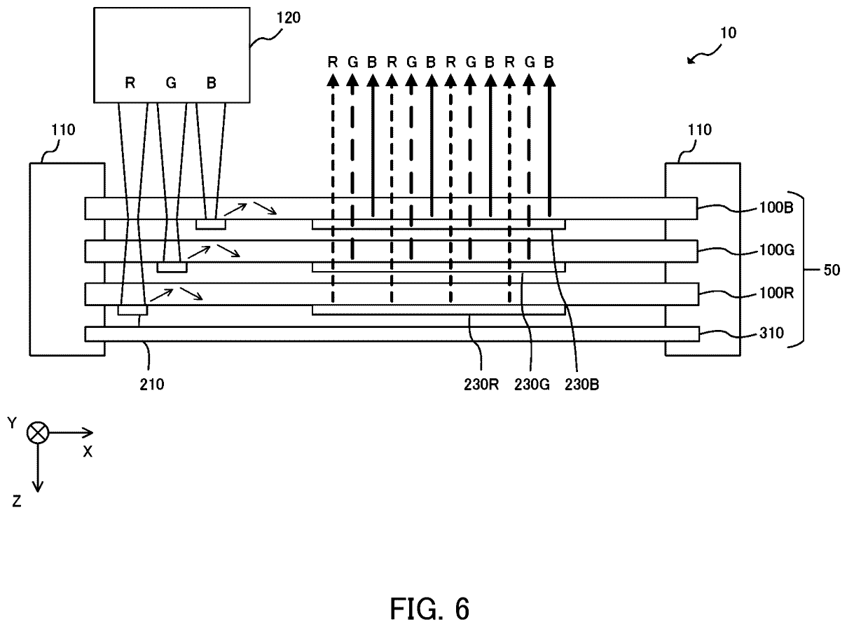

FIG. 6 shows a second configuration example of the glasses-type terminal 10 according to the present embodiment. In the glasses-type terminal 10 of the second configuration example, components that function in approximately the same manner as those of the glasses-type terminal 10 according to the present embodiment shown in FIG. 1 are denoted by the same reference numerals, and redundant descriptions are omitted. The appearance of the glasses-type terminal 10 of the second configuration example may be approximately the same as that of the glasses-type terminal 10 shown in FIG. 1.

A plurality of projection substrates 100 are fixed to the frame 110 of the glasses-type terminal 10 of the second configuration example. In this configuration, the plurality of projection substrates 100 are fixed to the frame 110 in such a way that emission regions 230, provided on each of the plurality of projection substrates 100, overlap at least partially in a planar view that is approximately parallel to the XY plane. FIG. 6 shows an example in which projection substrates 100R, 100G, and 100B are fixed to the frame 110 of the glasses-type terminal 10, and emission regions 230R, 230G, and 230B of the three projection substrates 100 overlap each other in the planar view in the XY plane.

The projection unit 120 radiates projection lights of different wavelengths onto the corresponding incident regions 210 provided on each of the plurality of projection substrates 100, respectively. By doing this, the emission regions 230 provided on each of the plurality of projection substrates 100 respectively emit image light, corresponding to the projection lights respectively radiated onto the plurality of incident regions 210 from the projection unit 120, from the second surface of the plurality of projection substrates 100 to the user's eyes.

Since the user wearing such a glasses-type terminal 10 observes an image in which the image lights of different wavelengths are superimposed, he/she can observe an image with colors resulting from color mixture. FIG. 6 shows an example in which the projection unit 120 radiates three projection lights corresponding to the three primary colors of RGB (such as red, green, and blue), which form an image, to the incident regions 210 of the three projection substrates 100, respectively. Then, the three projection substrates 100 superimpose three image lights corresponding to the three primary colors of RGB and emit the superimposed lights to the user's eyes. By doing this, the user can observe an image having a plurality of colors of 2″, for example. Here, n is a positive integer such as 4, 8, 16, or 24.

### Third Configuration Example of the Glasses-Type Terminal 10

In the glasses-type terminal 10 described above, since the optical waveguide 200 includes the diffraction grating, when light enters the projection substrate 100 at a predetermined angle from above the user wearing the glasses-type terminal 10, diffracted light diffracted by the diffraction grating may enter the user's eyes. The predetermined angle is, for example, between 30 degrees and 80 degrees. The predetermined angle may also be between 45 degrees and 80 degrees, or between 60 degrees and 80 degrees.

For example, sunlight, fluorescent light, and the like may travel from above the user toward the user, and when such light enters the eyes of the user as diffracted light, it may cause the user to feel uncomfortable or make it difficult for the user to see ahead. Therefore, it is preferable for the glasses-type terminal 10 according to the present embodiment to be configured to reduce such diffracted light. This configuration will be described next.

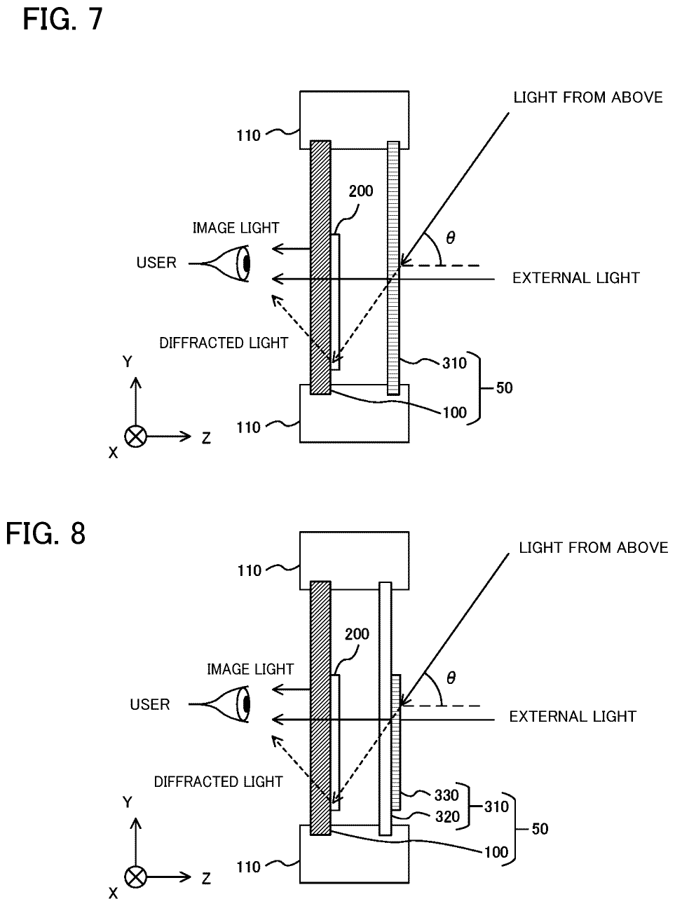

FIG. 7 shows a third configuration example of the glasses-type terminal 10 according to the present embodiment. In the glasses-type terminal 10 of the third configuration example, components that function in approximately the same manner as those of the glasses-type terminal 10 according to the present embodiment shown in FIG. 1 are denoted by the same reference numerals, and redundant descriptions are omitted. FIG. 7 is a diagram in which the projection unit 120 is omitted. The appearance of the glasses-type terminal 10 of the third configuration example may be approximately the same as that of the glasses-type terminal 10 shown in FIG. 1.

In the glasses-type terminal 10 of the third configuration example, the projection optical system 50 further includes the diffracted light reduction plate 310. The diffracted light reduction plate 310 is provided on the first surface side of the projection substrate 100, with an air layer interposed between itself and the optical waveguide 200 of the projection substrate 100. As described above, the diffracted light reduction plate 310 is provided apart from the optical waveguide 200 so as not to influence optical characteristics of the optical waveguide 200.

The diffracted light reduction plate 310 covers at least a part of the optical waveguide 200, which diffracts the input light incident from the first surface of the projection substrate 100 at a predetermined incident angle, and the diffracted light reduction plate 310 reduces diffracted light that travels in the emission direction of the image light. Here, the incident angle refers to the angle formed with the normal line of the boundary surface at the point where the input light intersects with the boundary surface of the medium, and is, for example, the angle indicated by θ in FIG. 7. The diffracted light reduction plate 310 covers, for example, at least a part of the output diffraction grating of the emission region 230. As a result, the diffracted light reduction plate 310 can receive the input light that travels from the first surface side of the projection substrate 100 at a predetermined incident angle to the diffraction grating of the optical waveguide 200.

Input light that has a predetermined incident angle and is traveling toward the diffraction grating of the optical waveguide 200 is diffracted by the diffraction grating. Among the diffracted light diffracted by the diffraction grating, a component that travels in the emission direction of the image light emitted from the second surface of the projection substrate 100 will be directed toward the eyes of the user and may enter user's field of view.

It is known that the intensity of the diffracted light diffracted by such a diffraction grating varies depending on the polarization direction of the light. For example, among the diffracted light, the intensity of P-polarized waves, which are parallel to the plane of incidence of the input light, is greater than the intensity of S-polarized waves, which are perpendicular to the plane of incidence of the input light. Therefore, the diffracted light reduction plate 310 is provided to reduce P-polarized light among the input light while allowing S-polarized light to pass through.

In this way, the diffracted light reduction plate 310 can reduce the intensity of the diffracted light traveling toward the eyes of the user even when light enters from above the user wearing the glasses-type terminal 10. Additionally, since the diffracted light reduction plate 310 transmits the S-polarized light among the input light to the projection substrate 100, the diffracted light reduction plate 310 can transmit at least a part of the external light, allowing the user to visually recognize it

FIG. 7 shows an example in which the diffracted light reduction plate 310 is provided facing the first surface of the projection substrate 100 and includes a polarization filter that reduces the P-polarized waves parallel to the plane of incidence of the input light incident on the diffracted light reduction plate 310. The polarizing filter is a polarizing plate, a polarizing film, or the like that attenuates the component of the incident light that is linearly polarized in a predetermined direction. The diffracted light reduction plate 310 is preferably fixed to the frame 110 or the projection substrate 100. It should be noted that the diffracted light reduction plate 310 may be configured such that the polarization filter is rotatably provided, allowing adjustment of the polarization direction (absorption axis) of the light to be reduced.

As described above, FIG. 7 illustrates an example in which the diffracted light reduction plate 310 reduces the P-polarized waves of the input light entering the projection substrate 100 in order to reduce the diffracted light diffracted by the optical waveguide portion 200 of the projection substrate 100, but the present invention is not limited thereto. For example, the diffracted light reduction plate 310 may reduce the P-polarized waves of the diffracted light diffracted by the optical waveguide portion 200 of the projection substrate 100.

In this case, the diffracted light reduction plate 310 is provided facing the second surface of the projection substrate 100 and reduces the P-polarized waves of the light emitted from the projection substrate 100. In other words, the diffracted light reduction plate 310 is provided between the user and the projection substrate 100. Even in such an arrangement of the diffracted light reduction plate 310, similarly to the arrangement shown in FIG. 7, the intensity of the diffracted light traveling toward the eyes of the user can be reduced. The diffracted light reduction plate 310 may be a polarizing film coated on a transparent substrate or the like. Next, the diffracted light reduction plate 310 configured in this manner will be described.

### Fourth Configuration Example of the Glasses-Type Terminal 10

FIG. 8 shows a fourth configuration example of the glasses-type terminal 10 according to the present embodiment. In the glasses-type terminal 10 of the fourth configuration example, components that function in approximately the same manner as those of the glasses-type terminal 10 according to the present embodiment shown in FIGS. 1 and 7 are denoted by the same reference numerals, and redundant descriptions are omitted. The appearance of the glasses-type terminal 10 of the fourth configuration example may be approximately the same as that of the glasses-type terminal 10 shown in FIG. 1.

In the glasses-type terminal 10 of the fourth configuration example, the diffracted light reduction plate 310 includes a protective substrate 320 and a polarizing film 330. The protective substrate 320 is provided facing the first surface of the projection substrate 100. Alternatively, the protective substrate 320 may be provided facing the second surface of the projection substrate 100. The protective substrate 320 is a substrate, such as a glass substrate or a plastic substrate that is transparent to at least visible light.

The polarizing film 330 is coated on at least one of a third surface or a fourth surface of the protective substrate 320, the third surface being on the side opposite to the projection substrate 100 and the fourth surface facing the projection substrate 100. FIG. 8 illustrates an example in which the polarizing film 330 is coated on the third surface of the protective substrate 320.

Similar to the polarizing filter, the polarizing film 330 is a thin film that reduces the P-polarized waves parallel to the plane of incidence of the input light entering the diffracted light reduction plate 310. The polarizing film 330 may be coated on a part of or the entire protective substrate 320.

Similar to the diffracted light reduction plate 310 described with reference to FIG. 7, the diffracted light reduction plate 310 having the protective substrate 320 and the polarizing film 330 can also reduce the intensity of diffracted light traveling toward the eyes of the user. The protective substrate 320 is preferably fixed to the frame 110 or the projection substrate 100. Additionally, the protective substrate 320 may be rotatably provided, and may be configured to allow adjustment of the direction of the absorption axis of the diffracted light reduction plate 310.

### Fifth Configuration Example of the Glasses-Type Terminal 10

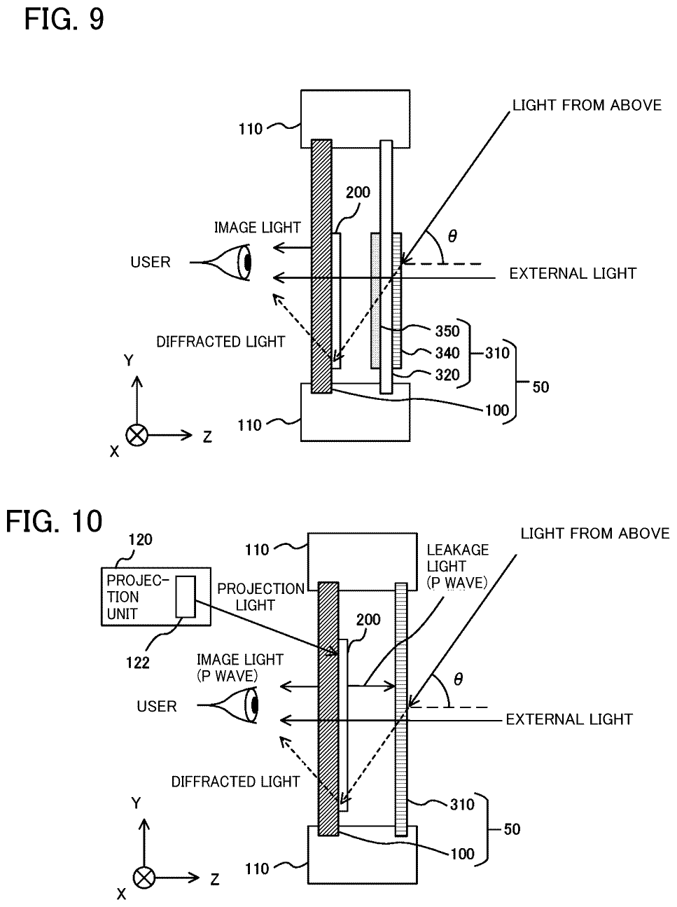

FIG. 9 shows a fifth configuration example of the glasses-type terminal 10 according to the present embodiment. In the glasses-type terminal 10 of the fifth configuration example, components that function in approximately the same manner as those of the fourth configuration example of the glasses-type terminal 10 shown in FIG. 8 are denoted by the same reference numerals, and redundant descriptions are omitted. The diffracted light reduction plate 310 of the fifth configuration example includes the protective substrate 320, a polarizing filter 340, and an infrared cut filter 350.

The polarization filter 340 is provided on the third surface of the protective substrate 320, which is on the side opposite to the projection substrate 100, and reduces the P-polarized waves parallel to the plane of incidence of the input light incident on the diffracted light reduction plate 310. The polarizing filter 340 is a polarizing plate, a polarizing film, or the like. Additionally, the polarizing filter 340 may be the same polarizing film described in FIG. 8. With such a polarization filter 340, the intensity of diffracted light traveling toward the eyes of the user can be reduced, as described in FIGS. 7 and 8.

The infrared cut filter 350 is provided on the fourth surface of the protective substrate 320, which faces the projection substrate 100, and reduces light in the infrared region among the input light. The infrared cut filter 350 is, for example, an IR cut filter that reduces near-infrared light using a multilayer film.

The infrared cut filter 350 reduces the light in the infrared region among the input light when the incident angle of the input light entering the filter is about 0 degrees. The infrared cut filter 350 also reduces light in the visible region when the incident angle of the input light is increased to, for example, 50 degrees or more. Therefore, the infrared cut filter 350 can reduce input light in the visible range that enters the projection substrate 100 from above the user at a predetermined angle. Therefore, the glasses-type terminal 10 of the fifth configuration example can further reduce the intensity of the diffracted light traveling toward the eyes of the user.

It should be noted that although the diffracted light reduction plate 310 shown in FIG. 9 illustrates an example in which the polarization filter 340 is provided on the third surface of the protective substrate 320 and the infrared cut filter 350 is provided on the fourth surface of the protective substrate 320, the embodiment is not limited thereto. In the diffracted light reduction plate 310, the infrared cut filter 350 may be provided on the third surface of the protective substrate 320, and the polarization filter 340 may be provided on the fourth surface of the protective substrate 320.

### Sixth Configuration Example of the Glasses-Type Terminal 10

In the glasses-type terminal 10 according to the present embodiment described above, an example has been described in which the diffracted light diffracted by the optical waveguide portion 200 of the projection substrate 100 is reduced. The glasses-type terminal 10 may be further configured to reduce image light leaking from the first surface of the projection substrate 100.

In the glasses-type terminal 10, a part of the image light that is supposed to be emitted toward the user may sometimes be emitted as leakage light in a direction other than that of the user. For example, a part of the image light emitting from the second surface of the projection substrate 100 may be unintentionally emitted from the first surface of the projection substrate 100 due to the diffraction grating of the optical waveguide 200. In this case, a person looking at the user may perceive the user's eyes as glowing, which could cause discomfort.

Since the image light leaked from the output diffraction grating is guided through a plurality of diffraction gratings of the optical waveguide 200, the leaked image light becomes light polarized in one direction corresponding to the structure of the optical waveguide 200. Therefore, by providing the diffracted light reduction plate 310 to face the first surface of the projection substrate 100 and approximately aligning the polarization direction of the image light with the polarization direction (absorption axis) of the light to be reduced by the diffracted light reduction plate 310, the intensity of the leaked image light can be reduced. Next, the glasses-type terminal 10 configured in this manner will be described.

FIG. 10 shows a sixth configuration example of the glasses-type terminal 10 according to the present embodiment. In the glasses-type terminal 10 of the sixth configuration example, components that function in approximately the same manner as those of the third configuration example of the glasses-type terminal 10 shown in FIG. 7 are denoted by the same reference numerals, and redundant descriptions are omitted. The glasses-type terminal 10 of the sixth configuration example are configured such that the polarization direction of the image light can be adjusted.

The projection unit 120 includes a polarization adjustment unit 122 that adjusts the polarization direction of the projection light to be radiated onto the incident region of the optical waveguide 200. The polarization adjustment unit 122 includes, for example, a wave plate that rotates the polarization direction of linearly polarized light. Then, the polarization adjustment unit 122 adjusts the polarization direction of the projection light so that the polarization direction of the image light approximately aligns with the polarization direction of the light that the diffracted light reduction plate 310 reduces. For example, the polarization adjustment unit 122 adjusts the polarization direction of the projection light so that the polarization direction of the image light becomes P-polarized with respect to the diffracted light reduction plate 310.

Accordingly, the diffracted light reduction plate 310 can reduce the leakage light of the image light emitted from the first surface of the projection substrate 100. In other words, while reducing diffracted light traveling toward the eyes of the user, the diffracted light reduction plate 310 can also reduce the intensity of the leaked image light to such an extent that it is not noticeable to others when they look at the user wearing the glasses-type terminal 10. Additionally, since the diffracted light reduction plate 310 transmits the light with a polarization direction perpendicular to that of the leaked image light, the diffracted light reduction plate 310 can transmit at least a part of the external light, allowing the user to visually recognize it.

### Seventh Configuration Example of the Glasses-Type Terminal 10

In the glasses-type terminal 10 according to the present embodiment described above, the diffracted light reduction plate 310 has a polarization filter or the like that reduces light having a predetermined polarization direction, and reduces the diffracted light diffracted by the optical waveguide portion 200 of the projection substrate 100, but the present invention is not limited thereto. The diffracted light reduction plate 310 may include, for example, a light control filter that changes the amount of light that diffuses input light according to the incident angle of the input light.

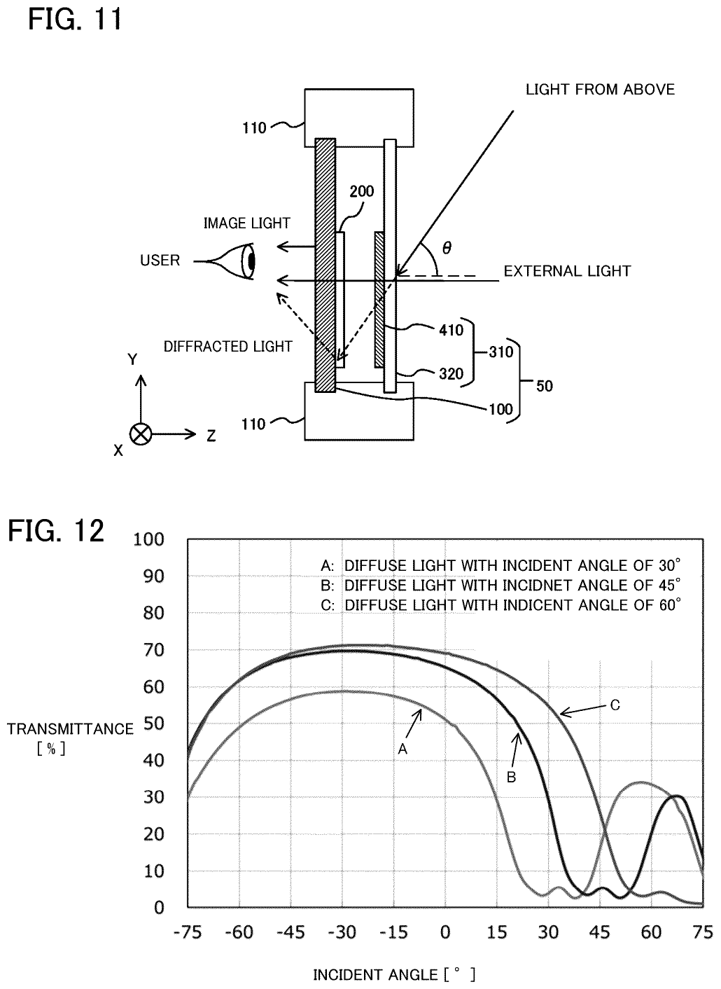

FIG. 11 shows a seventh configuration example of the glasses-type terminal 10 according to the present embodiment. In the glasses-type terminal 10 of the seventh configuration example, components that function in approximately the same manner as those of the fourth configuration example of the glasses-type terminal 10 shown in FIG. 8 are denoted by the same reference numerals, and redundant descriptions are omitted. The diffracted light reduction plate 310 of the seventh configuration example includes the protective substrate 320 and a light control filter 410.

The light control filter 410 is provided on at least one of the third surface or the fourth surface of the protective substrate 320, the third surface being on the side opposite to the projection substrate 100 and the fourth surface facing the projection substrate 100. The light control filter 410 allows input light incident on the diffracted light reduction plate 310 at an incident angle in a first angle range to pass through to the optical waveguide 200.

The first angle range includes an angle of about 0°. For example, the first angle range may be in the range of +30° to −30°, and may instead be in the range of +20° to −20°. The first angle range may be in the range of +10° to −10°. In addition, the first angle range may include a greater range of incident angles that differ in sign from the predetermined incident angle of the input light at which the optical waveguide 200 generates diffracted light. For example, when the sign of the predetermined incident angle is +, the first angle range is a range from +20° to −70°. Alternatively, the first angle range may be in the range of +10° to −60°.

For example, the light control filter 410 directs input light having an incident angle of about 0° to pass through to the optical waveguide 200. In this way, when the glasses-type terminal 10 are worn by the user, the user can visually recognize the external light.

Additionally, when the input light enters the diffracted light reduction plate 310 at an incident angle in a second angle range different from the first angle range, the light control filter 410 diffuses the input light and attenuates the amount of light that travels straight to and reaches the optical waveguide 200 as compared with the case where the input light enters at an incident angle in the first angle range. The second angle range of the input light for the light control filter 410 is a range of angles greater than the angles of the first angle range.

The light control filter 410 diffuses input light having an incident angle of, for example, +30° to +80°, and attenuates the amount of light passing through to the optical waveguide 200. The light control filter 410 may diffuse input light having an incident angle of +45° to +80° or may diffuse input light having an incident angle of +60° to +80°.

The second angle range of the input light for the light control filter 410 includes a predetermined incident angle of the input light, which has entered from the first surface of the projection substrate 100 and causes the optical waveguide 200 to generate diffracted light. In this way, even when the input light having a predetermined incident angle enters the diffracted light reduction plate 310, the light control filter 410 reduces the input light that reaches the optical waveguide 200 while maintaining a direction that is approximately aligned with the incident direction of the input light. As a result, the diffracted light reduction plate 310 can reduce the intensity of the diffracted light that is diffracted by the optical waveguide 200 and directed toward the eyes of the user.

The light control filter 410 may be attached to the protective substrate 320, or alternatively, it may be formed by depositing a filter material on at least one of the third surface or the fourth surface of the protective substrate 320. An example of the actual optical characteristics of such a light control filter 410 is shown in FIG. 12.

FIG. 12 shows an example of transmittance characteristics of the light control filter 410 according to the present embodiment. In FIG. 12, the horizontal axis represents the incident angle of light incident on the light control filter 410, and the vertical axis represents the transmittance. Here, the transmittance is the transmittance of light emitted in a direction that is approximately aligned with the incident direction of light, and may be referred to as linear transmittance. The linear transmittance is, for example, a value obtained by multiplying, by 100, the ratio of the amount of light detected by a light detector after passing through the light control filter 410 to the amount of light detected by the light detector without the light control filter 410, for the same input light. Such linear transmittance decreases as a component of diffused light among the input light increases.

A in FIG. 12 illustrates a light control filter 410 designed to further diffuse input light having an incident angle of +30°, thereby reducing the input light. Similarly, B in FIG. 12 is a light control filter 410 designed to further diffuse input light at an incident angle of +45°, thereby reducing the input light, and C is a light control filter 410 designed to further diffuse input light at an incident angle of +60°, thereby reducing the input light.

It can be seen that any of the light control filters 410 (A to C) can reduce the input light entering at a predetermined incident angle while transmitting 50% or more of the input light with an incident angle about 0°. Since such light control filters 410 are known as anisotropic optical films or the like, as described in Patent Document 2, a detailed description of their structures is omitted here.

In the diffracted light reduction plate 310 of the glasses-type terminal 10 of the seventh configuration example shown in FIG. 11, the light control filter 410 may be oriented toward one surface of the protective substrate 320, or may be provided on both surfaces. Alternatively, the light control filter 410 may be provided on one surface of the protective substrate 320, and the polarization filter 340 may be provided on the other surface. Further, the light control filter 410 may be provided on one surface of the protective substrate 320, and the infrared cut filter 350 may be provided on the other surface. Even in such configurations, the diffracted light reduction plate 310 can reduce the intensity of the diffracted light that is diffracted by the optical waveguide 200 and traveling toward the eyes of the user.

### Another Configuration Example of the Glasses-Type Terminal 10

In the glasses-type terminal 10 according to the present embodiment, an example has been described in which the diffracted light reduction plate 310 is provided facing the second surface of the projection substrate 100. In this case, since the diffracted light reduction plate 310 is provided between the projection substrate 100 and the user, the diffracted light reduction plate 310 is configured to transmit the image light emitted from the projection substrate 100 toward the user while reducing the diffracted light.

Even in this case, the glasses-type terminal 10 may be configured such that the polarization direction of the image light can be adjusted. For example, as described above, the projection unit 120 includes the polarization adjustment unit 122 that adjusts the polarization direction of the projection light to be radiated onto the incident region of the optical waveguide 200. Then, the polarization adjustment unit 122 adjusts the polarization direction of the projection light so that the polarization direction of the image light approximately aligns with the polarization direction of the light that the diffracted light reduction plate 310 transmits. As one example, the polarization adjustment unit 122 adjusts the polarization direction of the projection light so that the polarization direction of the image light becomes S-polarized with respect to the diffracted light reduction plate 310.

Accordingly, even when the diffracted light reduction plate 310 is provided between the projection substrate 100 and the user, while reducing the diffracted light traveling toward the eyes of the user, the diffracted light reduction plate 310 can transmit the image light emitted from the projection substrate 100 toward the user, allowing the user to visually recognize it. Such a polarization adjustment unit 122 does not need to be provided when the polarization direction of the image light projected from the projection substrate 100 toward the user is approximately orthogonal to the absorption axis of the diffracted light reduction plate 310 even without adjusting the polarization direction of the projection light.

In the glasses-type terminal 10 described above, as described with reference to FIG. 6, the projection optical system 50 may include the plurality of projection substrates 100 and allow the user to observe the image in which a plurality of image lights of different wavelengths are superimposed. In this case, it is preferable that the polarization directions of the plurality of image lights approximately align.

The diffracted light reduction plate 310 is provided (i) on the user-opposite side of the plurality of projection substrates 100 or (ii) between the plurality of projection substrates 100 and the user. FIG. 6 shows an example in which the projection optical system 50 includes three projection substrates 100 and one diffracted light reduction plate 310 provided on the user-opposite side of the three projection substrates 100.

When the projection optical system 50 includes a plurality of projection substrates 100, the diffracted light reduction plate 310 may be provided between two different projection substrates 100. Even in such an arrangement, the diffracted light reduction plate 310 can reduce diffracted light traveling toward the eyes of the user. In other words, the diffracted light reduction plate 310 is provided on the user-opposite side of one projection substrate 100 among the plurality of projection substrates 100, or between the one projection substrate 100 and the user. Additionally, the projection optical system 50 may include a plurality of such diffracted light reduction plates 310.

In the case where the projection optical system 50 includes the plurality of projection substrates 100, the glasses-type terminal 10 may be configured such that the polarization direction of the image light can be adjusted. For example, the projection unit 120 includes a polarization adjustment unit 122 that adjusts the polarization direction of at least one projection light among a plurality of projection lights to be radiated onto the incident regions. The projection unit 120 may include a polarization adjustment unit 122 that adjusts the polarization directions of all the projection lights.

The diffracted light reduction plate 310 may be provided on the user-opposite side of the plurality of projection substrates 100. In this case, the polarization adjustment unit 122 adjusts the polarization direction of the projection light so as to align approximately the polarization direction of at least one of the plurality of image lights and the polarization direction of the light that the diffracted light reduction plate 310 reduces. In this way, the diffracted light reduction plate 310 can reduce the intensity of the image light leaked from the first surface of the at least one projection substrate 100, while reducing diffracted light traveling toward the eyes of the user.

It should be noted that the projection unit 120 may include a plurality of polarization adjustment units 122 that adjust the polarization directions of a plurality of projection lights corresponding to the plurality of projection lights to be radiated onto the incident region 210. In this case, the projection unit 120 can adjust the polarization directions of the plurality of projection lights so that leakage lights corresponding to the plurality of projection lights are appropriately reduced by the diffracted light reduction plate 310 while efficiently guiding the plurality of projection lights in the optical waveguide 200.

Alternatively, the diffracted light reduction plate 310 may be provided between one of the plurality of projection substrates 100 and the user. In this case, the polarization adjustment unit 122 adjusts the polarization direction of the projection light so that the polarization direction of the image light emitted by one projection substrate 100, among the plurality of image lights, approximately aligns with the polarization direction of the light transmitted by the diffracted light reduction plate 310.

In this way, the diffracted light reduction plate 310 transmits the image light emitted toward the user from the second surface of the projection substrate 100, allowing the user to visually recognize the image light while reducing diffracted light traveling toward the eyes of the user. It is needless to say that, even in this case, the projection unit 120 may include a plurality of polarization adjustment units 122 that adjust the polarization directions of a plurality of projection lights corresponding to the plurality of projection lights to be radiated onto the incident region 210.

In the glasses-type terminal 10 according to the present embodiment, an example has been described in which the diffracted light reduction plate 310 is provided to cover at least a part of the optical waveguide 200. The diffracted light reduction plate 310 does not need to cover the entire optical waveguide 200, as long as it can reduce diffracted light traveling toward the eyes of the user. In such a case, the diffracted light reduction plate 310 may be provided in a range above the lower end of the optical waveguide 200 when the glasses-type terminal 10, including the projection optical system 50, are worn in a manner that covers the user's eyes.

Alternatively or additionally, when the diffracted light generated at the upper end of the optical waveguide 200 travels upward beyond the eyes of the user, the diffracted light reduction plate 310 does not need to cover the upper end of the optical waveguide 200. The diffracted light reduction plate 310 is provided such that, for example, 1% to 20% or 1% to 30% of the optical waveguide 200's area remains exposed. Alternatively, the diffracted light reduction plate 310 may be provided such that 1% to 40% of the optical waveguide 200's area remains exposed. As described above, by forming the diffracted light reduction plate 310 on the protective substrate 320 with an area smaller than that of the optical waveguide 200, the user's visibility can be improved, and manufacturing cost can be reduced.

In addition, when the diffracted light generated at the upper end of the optical waveguide 200 travels toward the eyes of the user, the diffracted light reduction plate 310 may be formed to cover a region of the projection substrate 100 where the optical waveguide 200 is not formed. For example, the diffracted light reduction plate 310 may be provided in a range including a position above the optical waveguide 200 when the glasses-type terminal 10, including the projection optical system 50, are worn in a manner that covers the user's eyes. In this way, the diffracted light reduction plate 310 can reduce diffracted light traveling toward the eyes of the user.

In the glasses-type terminal 10 according to the present embodiment described above, an example has been described in which the optical waveguide 200 of the projection substrate 100 includes the incident region 210, the intermediate region 220, and the emission region 230. However, the present invention is not limited to this configuration. The optical waveguide 200 only needs to be capable of outputting the projection light incident from the projection unit 120 as image light to be observed by the user, and the shapes or other aspects of the incident region 210, intermediate region 220, and emission region 230 are not limited to the described example. Additionally, the optical waveguide 200 may, for example, have a configuration in which it includes the incident region 210 and the emission region 230 but does not include the intermediate region 220.

The present invention is explained based on the exemplary embodiments. The technical scope of the present invention is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

1. A projection optical system comprising:
a projection substrate for projecting an image light onto a second surface while transmitting at least a part of light, that is incident from a first surface, to the second surface opposite to the first surface, the projection substrate having an optical waveguide; and
a diffracted light reduction plate that (i) is provided on the first surface side or the second surface side of the projection substrate, with an air layer between itself and the optical waveguide, (ii) covers at least a part of the optical waveguide, which diffracts an input light incident from the first surface of the projection substrate at a predetermined incident angle, and (iii) reduces diffracted light that travels in an emission direction of the image light, wherein
the optical waveguide guides at least a part of projection light for projecting the image light, and emits the at least part of the projection light as the image light from the second surface.

2. The projection optical system according to claim 1, wherein the diffracted light reduction plate has:
a protective substrate that is provided facing the first surface or the second surface of the projection substrate;
a polarization filter provided on one of a third surface or a fourth surface of the protective substrate, the third surface being on the side opposite to the projection substrate and the fourth surface facing the projection substrate, and that reduces P-polarized waves parallel to a plane of incidence of the input light incident on the diffracted light reduction plate; and
an infrared cut filter provided on a surface of the protective substrate opposite to a surface on which the polarization filter is provided, and that reduces light in the infrared region among the input light.

3. The projection optical system according to claim 1, wherein the diffracted light reduction plate is provided facing the first surface or the second surface of the projection substrate, and has a polarization filter that reduces P-polarized waves parallel to a plane of incidence of the input light that has entered the diffracted light reduction plate.

4. The projection optical system according to claim 1, wherein the diffracted light reduction plate has:
a protective substrate that is provided facing the first surface or the second surface of the projection substrate; and
a polarizing film that is coated on at least one of a third surface or fourth surface of the protective substrate, the third surface being on the side opposite to the projection substrate and the fourth surface facing the projection substrate, and that reduces P-polarized waves parallel to a plane of incidence of the input light incident on the diffracted light reduction plate.

5. The projection optical system according to claim 1, wherein the diffracted light reduction plate has:
a protective substrate that is provided facing the first surface or the second surface of the projection substrate; and
a light control filter provided on at least one of a third surface or a fourth surface of the protective substrate, the third surface being on the side opposite to the projection substrate and the fourth surface facing the projection substrate, allows the input light incident on the diffracted light reduction plate at an incident angle in a first angle range to pass through the optical waveguide, diffuses the input light incident on the diffracted light reduction plate at an incident angle in a second angle range different from a first angle range and attenuates an amount of light that travels straight to and reaches the optical waveguide as compared with a case where the input light enters at an incident angle in the first angle range.

6. The projection optical system according to claim 5, wherein the light control filter is formed by depositing a filter material on at least one of the third surface or the fourth surface of the protective substrate.

7. The projection optical system according to claim 5, wherein the second angle range of the light control filter includes the predetermined incident angle of the input light, which has entered from the first surface of the projection substrate and causes the optical waveguide to generate diffracted light.

8. The projection optical system according to claim 1, wherein the diffracted light reduction plate is provided in a range including a position above the optical waveguide when glasses-type terminal, including the projection optical system, are worn in a manner that covers the eyes of a user.

9. The projection optical system according to claim 8, wherein the diffracted light reduction plate is provided in a range above a lower end of the optical waveguide when glasses-type terminal, including the projection optical system, are worn in a manner that covers the eyes of a user.

10. The projection optical system according to claim 1, wherein the optical waveguide has:
an incident region, into which a projection light for projecting the image light enters, which includes an input diffraction grating and guides the incident projection light inside the projection substrate; and
an emission region that includes an output diffraction grating, guides at least a part of the projection light incident from the incident region, and emits the at least part of the projection light as the image light from the second surface, and the diffracted light reduction plate covers at least a part of the output diffraction grating.

11. The projection optical system according to claim 10, wherein the optical waveguide further has an intermediate region that includes an intermediate diffraction grating and guides a part of the projection light incident from the incident region toward the emission region, in the input diffraction grating, a plurality of first grooves are formed with a first period, in the intermediate diffraction grating, a plurality of second grooves are formed with a second period, and in the output diffraction grating, a plurality of third grooves are formed with a third period.

12. A Glasses-type terminal worn by a user, comprising:
the projection optical system according to claim 1, which is provided as at least one of a lens for the right eye and a lens for the left eye of the user, and projects the image light onto the second surface while transmitting at least a part of light incident from the first surface to the eye of the user;
a frame that fixes the projection optical system; and
a projection unit that is provided in the frame and radiates the projection light, for causing the image light to be projected onto an emission region of the optical waveguide, onto an incident region of the optical waveguide of the projection substrate.

13. The glasses-type terminal according to claim 12, wherein the projection unit has a polarization adjustment unit that adjusts a polarization direction of the projection light to be radiated onto the incident region, the diffracted light reduction plate of the projection optical system is provided facing the first surface of the projection substrate, and the polarization adjustment unit adjusts the polarization direction of the projection light so that a polarization direction of the image light matches a polarization direction of the light that the diffracted light reduction plate reduces.

14. The glasses-type terminal according to claim 12, wherein the projection unit has a polarization adjustment unit that adjusts a polarization direction of the projection light to be radiated onto the incident region, the diffracted light reduction plate of the projection optical system is provided facing the second surface of the projection substrate, and the polarization adjustment unit adjusts the polarization direction of the projection light so that a polarization direction of the image light matches a polarization direction of the light that the diffracted light reduction plate transmits.

15. The glasses-type terminal according to claim 12, wherein a plurality of the projection substrates are fixed to the frame, the diffracted light reduction plate is provided on (i) the user-opposite side of one projection substrate among the plurality of projection substrates or (ii) between the one projection substrate and the user, the projection unit radiates the projection light, including different wavelengths, onto the respective incident regions provided on each of the plurality of projection substrates, and the emission regions, provided on each of the plurality of projection substrates, overlap at least partially in a planar view, and respectively emit the image light, corresponding to the projection light radiated onto a plurality of the incident regions from the projection unit, from the second surface of the plurality of projection substrates to the eyes of the user.

16. The glasses-type terminal according to claim 15, wherein the projection unit has a polarization adjustment unit that adjusts a polarization direction of at least one projection light among a plurality of the projection lights to be radiated onto the incident regions,
the diffracted light reduction plate of the projection optical system is provided on the user-opposite side of the plurality of projection substrates, and the polarization adjustment unit adjusts the polarization direction of the projection light so as to match a polarization direction of at least one of a plurality of the image lights and a polarization direction of the light that the diffracted light reduction plate reduces.

17. The glasses-type terminal according to claim 15, wherein the projection unit has a polarization adjustment unit that adjusts a polarization direction of at least one projection light among the plurality of projection lights to be radiated onto the incident regions, the diffracted light reduction plate of the projection optical system is provided between (i) one projection substrate among the plurality of projection substrates and (ii) the user, and the polarization adjustment unit adjusts the polarization direction of the projection light so that a polarization direction of the image light emitted by the one projection substrate, among the plurality of image lights, matches a polarization direction of the light that the diffracted light reduction plate transmits.
